(19) United States
(12) Patent Application Publication
(10) Pub. No.: US 2026/0299967 A1
(43) Pub. Date: Oct. 1, 2026

(54) SYSTEMS AND METHODS FOR SELECTING A DEVICE SOFTWARE FOR A CONNECTED HOUSEHOLD APPLIANCE

(71) Applicant: Haier US Appliance Solutions, Inc., Wilmington, DE (US)

(72) Inventor: Samuel Ryan, Louisville, KY (US)

(21) Appl. No.: 19/091,991

(22) Filed: Mar. 27, 2025

(51) Int. Cl. G06F 9/445

(52) U.S. Cl. CPC G06F 9/44536

(57) ABSTRACT

A connected household appliance may include one or more sub-control boards that may each include a memory having an appliance identifier corresponding to the connected household appliance stored therein. The connected household appliance may include a main control board in operative communication with the one or more sub-control board. The main control board may be operable for: transmitting one or more read requests to the one or more sub-control boards, obtaining the appliance identifier from each memory of the one or more sub-control boards in response to transmitting the read request, and implementing a target device software corresponding to an external device based on the appliance identifiers obtained.

### FIELD OF THE DISCLOSURE

The present subject matter relates generally to a connected household appliance, and more particularly to systems and methods for selecting a software for a connected household appliance.

### BACKGROUND OF THE DISCLOSURE

Household appliances are increasingly becoming smarter and more connected with the advancement of the internet age. Many households include a plurality of network connected household appliances, such as refrigerators, laundry machines, oven appliance, or the like that can be connected to an external device (e.g., a smart device, smart speaker, etc.) via a network.

Such connected household appliances can include implement a device software for communicating or interfacing with the external device. However, existing methods for selecting a device software for a connected household appliance provide several drawbacks. For example, such existing methods can result in manufacturing complexity, high supply chain times, and high part counts for the connected household appliances.

Accordingly, systems and methods that obviate one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a connected household appliance is provided. The connected household appliance may include one or more sub-control boards that may each include a memory having an appliance identifier corresponding to the connected household appliance stored therein. The connected household appliance may include a main control board in operative communication with the one or more sub-control board. The main control board may be operable for: transmitting one or more read requests to the one or more sub-control boards, obtaining the appliance identifier from each memory of the one or more sub-control boards in response to transmitting the read request, and implementing a target device software corresponding to an external device based on the appliance identifiers obtained.

In another exemplary aspect of the present disclosure, a method for selecting a device software for a connected household appliance is provided. The connected household appliance may include one or more sub-control boards that may each include a memory having an appliance identifier corresponding to the connected household appliance stored therein. The connected household appliance may include a main control board in operative communication with the one or more sub-control board. The method may include transmitting one or more read requests to the one or more sub-control boards. The method may include obtaining the appliance identifier from each memory of the one or more sub-control boards in response to transmitting the read request. The method may include implementing a target device software corresponding to an external device based on the appliance identifiers obtained.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a system of connected household appliances according to one or more exemplary embodiments of the present subject matter.

FIG. 2 provides a schematic diagram of a connected household appliance according to one or more exemplary embodiments of the present subject matter.

FIG. 3 provides a flow chart illustrating a method for selecting a device software for a connected household appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure generally relate to connected household appliances (e.g., refrigerator appliances, oven appliances, microwave appliances, laundry appliances, water heater appliances, air conditioning appliances, or the like that can be in operative communication with one or more external devices, such as one or more smart home devices). Specifically, the connected household appliances can include a controller that communicates (e.g., wirelessly via a network) with the one or more of the external device (e.g., devices that are separate from or external to the one or more connected household appliances, and which may be configured for facilitating communications with various appliances or other devices).

Many existing external devices require unique device software, such as an unique device Appliance Programming Interface (API), for each different connected household appliance type. For example, a discrete external device can require a first connected household appliance (e.g., a connected refrigerator appliance) to implement a first unique device software (e.g., a first unique device API) that is related only to the first connected household appliance. Further, the discrete external device can require a second connected household appliance (e.g., a connected dishwasher appliance) to implement a second unique device software (e.g., a second unique device API) that is related only to the second connected household appliance.

Typically, the controller of each connected household appliance only includes the unique device software that corresponds to the connected household appliance type. For example, a controller of an existing connected refrigerator appliance only includes a device software (e.g., a device API) that is related only to the connected refrigerator appliance. Further, a controller of an existing connected dishwasher appliance only includes a device software (e.g., a device API) that is related only to the connected dishwasher appliance. However, such an implementation of unique device software on each different connected household appliances type can impart complexity to the manufacturing processing, the supply chain, and part procurement/retention.

Therefore, there is a need for a common main control board that can be installed in all different connected household appliances types. The main control board can be configured to store all unique device software (e.g., all device software for different appliance types) in a memory thereof. In addition, the main control board can implement the appropriate device software, for instance, at start/boot up of the connected household appliance, based on one or more appliance identifiers of the connected household appliance or one or more device identifiers of the external device attempting to interface with the connected household appliance.

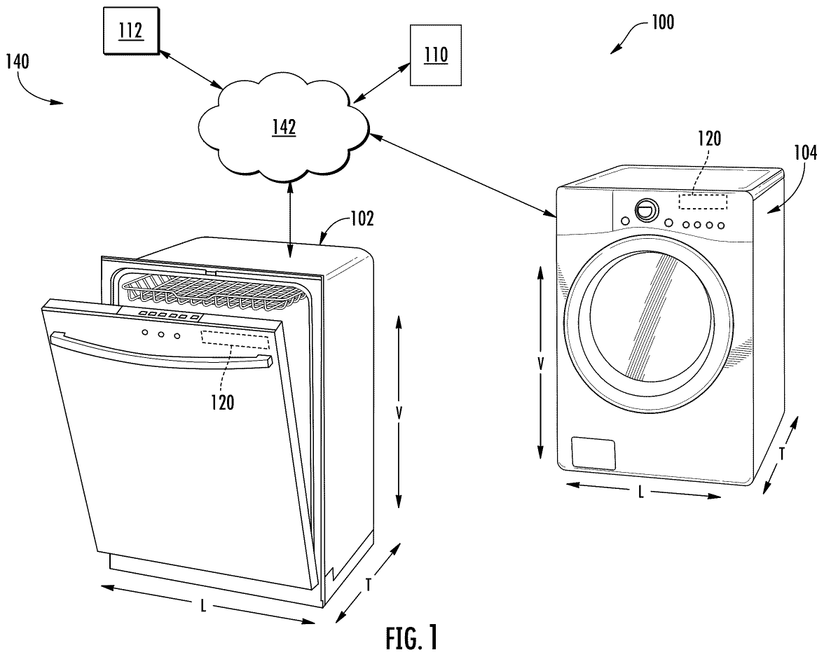

Referring now to FIG. 1, a system of connected household appliances 100 will be described according to exemplary embodiments of the present subject matter. In general, system of connected household appliances 100 may include any suitable number, type, and configuration of appliances, remote servers, network devices, or other external devices. Some of these connected household appliances 100 may be able to communicate with each other or are otherwise interconnected. This interconnection, interlinking, and interoperability of multiple appliances or devices may commonly be referred to as “smart home” or “connected home” appliance interconnectivity.

As shown, the system of connected household appliances 100 generally includes a first connected household appliance 102 (e.g., illustrated herein as a dishwasher appliance) and a second connected household appliance 104 (e.g., illustrated herein as a laundry appliance such as a washing machine appliance or a dryer appliance). Details regarding the operation of first connected household appliance 102 and second connected household appliance 104 may be understood by one having ordinary skill in the art and detailed discussion is omitted herein for brevity. However, it should be appreciated that the specific appliance types and configurations are only exemplary and are provided to facilitate discussion regarding the use and operation of an exemplary system of connected household appliances 100. The scope of the present subject matter is not limited to the number, type, and configurations of appliances set forth herein.

For example, the system of connected household appliances 100 may include any suitable number and type of “household appliances,” such as “connected household appliances.” These terms are used herein to describe appliances typically used or intended for common household or domestic tasks, e.g., such as the appliances as illustrated in the figures. According to still other embodiments, these “appliances” may include but are not limited to a dishwasher appliance, a microwave oven appliance, a cooktop appliance, an oven appliance, a washing machine appliance, a dryer appliance, a refrigerator appliance, a water heater appliance, a water filter or purifier, an air conditioner, a space heater, and any other household appliance which performs similar functions. Moreover, although only two appliances are illustrated, various embodiments of the present subject matter may also include another number of appliances, each of which may generate and store data.

In addition, it should be appreciated that system of connected household appliances 100 may include one or more external devices 110, e.g., devices that are separate from or external to the one or more connected household appliances, and which may be configured for interfacing with or controlling operating of the connected household appliances. For example, according to exemplary embodiments of the present subject matter, the system of connected household appliances 100 may include or be communicatively coupled with an external device 110 that may be configured to enable user interaction with some or all appliances or other devices in the system of connected household appliances 100.

In general, external device 110 may be any suitable device separate or spaced apart from the connected household appliances (e.g., such as first connected household appliance 102 and second connected household appliance 104) that is configured to control or direct operation of the connected household appliances. For example, the external device 110 may provide or receive communications, information, data, or commands from a user that may be utilized in controlling or directing operation of the connected household appliances. In this regard, for example, the external device 110 may be a smart home device, a personal phone, a smartphone, a tablet, a laptop or personal computer, a wearable device, or any other suitable device that is configured to provide or receive communication, information, data, or commands from a user. For example, the separate device may be a smart home device, such as an electronic device that can remotely control operation of the one or more connected household appliance (e.g., the first connected household appliance 102 or the second connected household appliance 104).

In some embodiments, a user may interact (e.g., directly or indirectly) with the external device 110, for instance, to control the one or more connected household appliances (e.g., the first connected household appliance 102 or the second connected household appliance 104). For example, a user may directly interact with or manipulate a user interface (e.g., a display, a control knob, an input selector, or the like) of the external device 110 to control operation of the connected household appliances. In some other embodiments, a user may indirectly interact with the external device 110, for instance, to control the one or more connected household appliances (e.g., the first connected household appliance 102 or the second connected household appliance 104). For example, a user may interact with a separate device, such as a smartphone, tablet, smartwatch, or the like operable to store and run applications (e.g., “apps”), that is operative communication with the external device 110 (e.g., via a network 142 described in more detail below) to control operation of the connected household appliances.

In addition, as will be described in more detail below, some or all of the system of connected household appliances 100 may include or be communicatively coupled with a remote server 112 that may be in operative communication with external device 110 or some or all appliances within system of connected household appliances 100. Thus, external device 110 or remote server 112 may refer to one or more devices that are not considered household appliances as used herein. In addition, devices such as a smart home device, personal computer, router, network devices, and other similar devices whose primary functions are network communication or data processing are not considered household appliances as used herein.

The first connected household appliance 102, the second connected household appliance 104, or any other suitable connected household appliance may include or be operably coupled to a controller 120. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information or data accessible by the one or more processors, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases or may be split up so that the data is stored in multiple locations. In addition, or alternatively, the one or more database(s) can be connected to controller 120 through any suitable communication module, communication lines, or network(s).

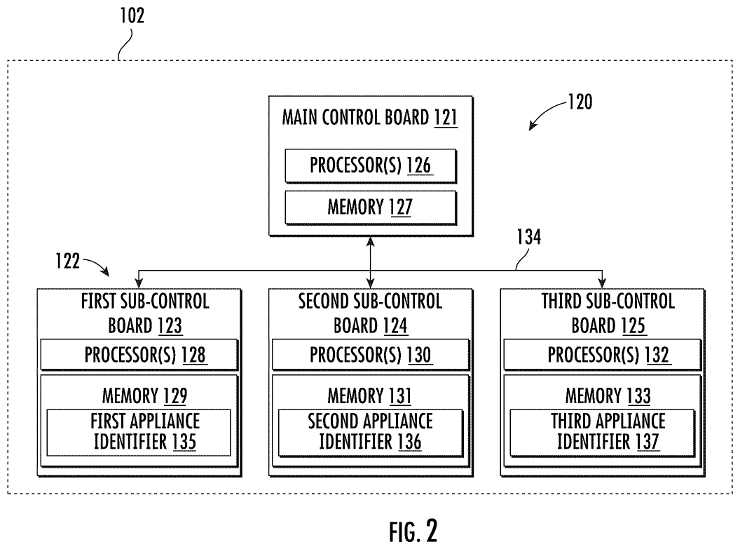

Referring now to FIG. 2, a schematic view of the first connected household appliance 102 is provided. As should be appreciated, only certain components of the first connected household appliance 102 are illustrated and described herein relation to FIG. 2 for the sake of brevity only. As should be appreciated, the second connected household appliance 104 or any other suitable connected household appliance may be configured in an identical or substantially similar manner as the first connected household appliance 102 illustrated and described in relation to FIG. 2.

As shown, the first connected household appliance 102 may include a main control board 121 and one or more sub-control boards 122 (e.g., a first sub-control board 123, a second sub-control board 124, and a third sub-control board 125) positioned within the first connected household appliance 102. The main control board 121 may include one or more processors 126 and a memory 127. The main control board 121 may include a list of deployable device software (e.g. a list of Application Programming Interfaces [APIs]) stored within the memory 127 thereof. The list of deployable device software may include a plurality of distinct deployable device software each corresponding to a distinct external device that may be configured to communicate with the first connected household appliance 102. For example, the list of deployable device software may include a first distinct deployable device software for a first external device (e.g., a first make or model of a smart home device) and a second distinct deployable device software for a second external device (e.g., a second make or model of a smart home device).

Moreover, the list of deployable device software may include distinct deployable device software for a plurality of distinct connected household appliance types. For example, the list of deployable device software may include a distinct deployable device software corresponding to one or more appliance types (e.g., dishwashing appliances, refrigerator appliances, water heater appliances, or the like) all may be stored within the memory of the main control board 121.

In this regard, the main control board 121 may be a “common” control board or module that may be utilized or installed in multiple distinct connected household appliance types. For example, the main control board 121 may be utilized in or installed in connected dishwashing appliances, connected refrigerator appliances, connected water heater appliances, or the like. As will be appreciated in more detail below, the main control board 121 may be configured to obtain appliance identifiers corresponding to the first connected household appliance 102 from the one or more sub-control boards 122 such that the main control board 121 may implement a target device software (e.g., a deployable device software from the list of deployable device software that corresponds to the first connected household appliance 102 and the external device that may request to communicate with the first connected household appliance 102).

In addition, the list of deployable device software may be updated or upgraded to add, remove, or update any deployable device software within the list of deployable device software. For example, the controller 120, and more particularly, the main control board 121 may receive over the air (OTA) updates to the list of deployable device software. The OTA updates may be downloaded and stored within the memory 127 of the main control board 121.

Each of the one or more sub-control boards 122 may also include respective one or more processors and a memory, e.g., in the manner described below for the main control board 121 For example, the first sub-control board 123 may include one or more processors(s) 128 and a memory 129, the second sub-control board 124 may include one or more processors(s) 130 and a memory 131, and the third sub-control board 125 may include one or more processors(s) 132 and a memory 133.

In some embodiments, the main control board 121 and the one or more sub-control boards 122 collectively form the controller 120 of the first connected household appliance 102. Thus, the main control board 121 and the one or more sub-control boards 122 may be configured to implement various programs or methods to operate the first connected household appliance 102. Input/output (“I/O”) signals may be routed between the main control board 121, the one or more sub-control boards 122, or various operational components of the connected household appliance, for example, along wiring harnesses that may be routed within the connected household appliance. For example, the main control board 121 may be capable of obtaining one or more appliance identifiers from the one or more sub-control boards 122, for instance, when selecting a device software to implement as described in more detail below.

The processor(s) (e.g., the processor(s) 126 of the main control board 121 or the processor(s) 128, 130, 132 of the one or more sub-control boards 122) of the can be any suitable processing device, such as a microprocessor, microcontroller, integrated circuit, or other suitable processing device. The memory (e.g., the memory 127 of the main control board 121 or the memory 129, 131, 133 of the one or more sub-control boards 122) of the first connected household appliance 102 can include any suitable computing system or media, including, but not limited to, non-transitory computer-readable media, RAM, ROM, hard drives, flash drives, or other memory devices.. The memory (e.g., the memory 127 of the main control board 121 or the memory 129, 131, 133 of the one or more sub-control boards 122) of the first connected household appliance 102 can store information accessible by processor(s) of the first connected household appliance 102, including instructions that can be executed by the processor(s) (e.g., the processor(s) 126 of the main control board 121 or the processor(s) 128, 130, 132 of the one or more sub-control boards 122) to control various components of the first connected household appliance 102 to provide appliance functionality. The processor(s) (e.g., the processor(s) 126 of the main control board 121 or the processor(s) 128, 130, 132 of the one or more sub-control boards 122) and memory (e.g., the memory 127 of the main control board 121 or the memory 129, 131, 133 of the one or more sub-control boards 122) of the first connected household appliance 102 may be mounted on a printed circuit board (PCB). Thus, e.g., it will be understood that each of main control board 121 and the one or more sub-control boards 122 each may be separate PCBs.

As shown in FIG. 2, the one or more sub-control boards 122 include three sub-control boards 122, more particularly the first sub-control board 123, the second sub-control board 124 and the third sub-control board 125. It will be understood that the number of sub-control boards 122 shown in FIG. 2 is provided by way of example only. Thus, first connected household appliance 102 may include less or more sub-control boards 122 in alternative example embodiments. As shown in FIG. 2, the one or more sub-control boards 122 may communicate with the main control board 121 via a wiring harness 134 that extends between and connects the one or more sub-control boards 122 and the main control board 121 within the first connected household appliance 102.

The one or more sub-control boards 122 may each include an appliance identifier (e.g., a first appliance identifier 135, a second appliance identifier 136, and a third appliance identifier 137) corresponding to the first connected household appliance 102. As used herein “appliance identifier” may refer to any suitable information or data that may be utilized in identifying parameters, aspects, or characteristics, of the first connected household appliance 102. The appliance identifier(s) may include information or data corresponding to a model number, a brand, an appliance category, or any other suitable information or data that may identify the first connected household appliance 102.

Each sub-control board 122 may include a unique appliance identifier stored within the respective memory. For example, the first sub-control board 123 may include the first appliance identifier 135 stored within the memory 129 that identifies a model number of the first connected household appliance 102, the second sub-control board 124 may include the second appliance identifier 136 stored within the memory 131 that identifies a brand of the first connected household appliance 102, and the third sub-control board 125 may include the third appliance identifier 137 stored within the memory 1333 that identifies category/type of the first connected household appliance 102. In some embodiments, the appliance identifier(s) are stored within a boot loader area of the memory 129, 131, 133 of the respective sub-control board 122. In some other embodiments, the appliance identifier(s) may be stored within any other, e.g., non-volatile or read only, portions of the memory 129, 131, 133 of the respective sub-control board 122.

Referring back to FIG. 1, a schematic diagram of an external communication system 140 will be described according to an exemplary embodiment of the present subject matter. In general, external communication system 140 is configured for permitting interaction, data transfer, and other communications between and among the first connected household appliance 102, the second connected household appliance 104, the external device 110, the remote server 112, other appliances within system of connected household appliances 100, or one or more external devices. For example, this communication may be used to provide and receive operating parameters, cycle settings, user instructions or notifications, performance characteristics, user preferences, or any other suitable information for improved performance of one or more appliances within system of connected household appliances 100. In addition, it should be appreciated that external communication system 140 may be used to transfer data or other information to improve performance of one or more external devices or appliances or improve user interaction with such devices.

In addition, remote server 112 may be in communication with the first connected household appliance 102, the second connected household appliance 104, or the external device 110 through a network 142. In this regard, for example, remote server 112 may be a cloud-based server, and is thus located at a distant location, such as in a separate state, country, etc. According to an exemplary embodiment, external device 110 may communicate with a remote server 112 over network 142, such as the Internet, to transmit/receive data or information, provide user inputs, receive user notifications or instructions, interact with or control the appliance, etc. In addition, external device 110 and remote server 112 may communicate with the appliance to communicate similar information.

In general, communication between the first connected household appliance 102, the second connected household appliance 104, external device 110, remote server 112, or other user devices or appliances may be carried using any type of wired or wireless connection and using any suitable type of communication network, non-limiting examples of which are provided below. For example, external device 110 may be in direct or indirect communication with the appliance through any suitable wired or wireless communication connections or interfaces, such as network 142. For example, network 142 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), or protection schemes (e.g., VPN, secure HTTP, SSL).

External communication system 140 is described herein according to an exemplary embodiment of the present subject matter. However, it should be appreciated that the exemplary functions and configurations of external communication system 140 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

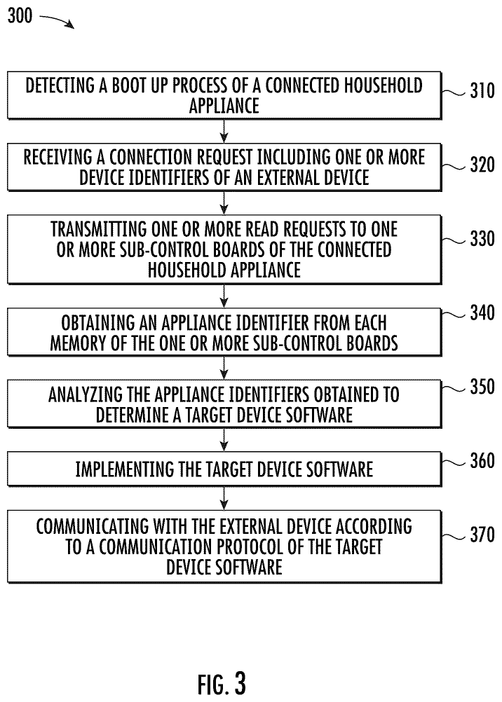

Turning now to FIG. 3, now that the construction of the system of connected household appliances 100, the controller 120, and the external communication system 140 according to one or more exemplary embodiments of the present subject matter have been presented, exemplary methods (e.g., method 300) of selecting a device software (e.g., a software, such as an API, specific to an external device, such as the external device 110) for a connected household appliance, such as the first connected household appliance 102 or the second connected household appliance 104, will be described.

Although the discussion below refers to the exemplary method for selecting a device software for a connected household appliance, such as the first connected household appliance 102 or the second connected household appliance 104, one skilled in the art would appreciate that the exemplary method discussed herein is applicable to operation of a variety of connected household appliances, for instance, a variety of other household appliances, such as refrigerator appliances, microwave oven appliances, water filters or water purifiers, air conditioner appliances, or any other suitable household appliance that may be connected to other appliances or external devices such as via a network.

In exemplary embodiments, the various method steps as disclosed herein may be performed (e.g., in whole or in part) by a controller of a connected appliance, and more particularly, by a main control board of the controller, such as the main control board 121 of the controller 120.

At 310, the method 300 includes detecting a boot up process of the connected household appliance (e.g., prior to 330 described below). In some embodiments, 310 includes determining the boot up process of the connected household appliance has been initiated. In such embodiments, determining the boot up process of the connected household appliance has been initiated includes detecting or determining a power connection to the connected household appliance. For example, when a connected household appliance is first powered on, such as when the connected household appliance is first connected to a power source and power is transmitted to the connected household appliance, the connected household appliance may automatically initiate the boot up process.

In some other embodiments, 310 includes detecting the boot up process of the connected household appliance has completed. For example, after the initiation of the boot up process, a start-up sequence of the connected household appliance may be performed. The start-up sequence may include operations such as delivering power to one or more control boards (e.g., the main control board or the one or more sub-control boards) of the connected household appliance, initiating or performing safety checks for the connected household appliance, directing operating of one or more components (e.g., fans, motors, etc.), or the like.

As should be appreciated, on initial boot up of the connected household appliance a device software condition stored within a memory of the main control board may be FALSE. When the default software condition is FALSE, no device software (e.g., a software configured to enable communication between the connected household appliance and an external device, such as a device specific API as described above) is implemented on the main control board. Thus, methods according to the present disclosure assume a device software is not present on the first time boot up of the connected household appliance, and therefore a device software will not be implemented at first installation of the connected household appliance. For example, the main control board will only select a device software (e.g., device specific API, that may correspond to the external device, such as a described above) to implement after boot up and after communication with the external device is requested (e.g., as discussed below with respect to 320 of method 300).

In yet some other embodiments, determining the boot up process of the connected household appliance has been initiated includes determining a reboot process of the connected household appliance has been initiated. For example, if the power has been removed from the connected household appliance for a predetermined time period, the connected household appliance may automatically enter a reboot process which may constitute a selection, or reselection of a device software. In this regard, if power has been removed for longer than 30 seconds, 1 minute, or some other time period, the connected household appliance may be programmed to revert to the device software condition of FALSE on initial boot up.

At 320, the method 300 includes receiving a connection request that may include one or more device identifiers of an external device. The external device may be, for example, an electronic device such as a smart home device, that may wirelessly control or direct operation of the connected household appliance. In some embodiments, the connection request is received from the external device. For example, the external device may transmit the connection request via a network, such as a local wireless network, following the boot up process of the connected household appliance being detected (e.g., at 310). The one or more device identifiers may include any suitable data or information that may be utilized in identifying the external device. For example, the one or more device identifiers may include information such as a make, model, serial number, or any other suitable data or information that may identify the external device.

As should be appreciated, the external device may request to connect with the connected household appliance prior to establishing communication with the connected household appliance. As will be described in more detail below, the connected household appliance may be required to implement a target device software prior to the external device being able to control or direct operation of the connected household appliance. In this regard, the connection request may be received when an external device is attempting to establish communication with the connected household appliance, such as during a commissioning process of the external device.

At 330, the method 300 includes transmitting one or more read requests to one or more sub-control boards of the connected household appliance. In some embodiments, the one or more read requests are transmitted from the main control board in response to receiving the connection request. For example, in response to receiving the connection request (e.g., from the external device), the main control board of the connected household appliance may transmit read requests to the one or more sub-control boards of the connected household appliance. As described above, the one or more sub-control boards each may include an appliance identifier (e.g., stored within a memory of the one or more sub-control boards) that identifies the connected household appliance. For example, the one or more sub-control boards may include appliance identifiers such as a model number, make, appliance category/type or any other suitable identifying characteristic, parameter, or quality of the connected household appliance stored with the memory. In some embodiments, the one or more sub-control boards are separate from the main control board of the connected household appliance. For example, the one or more sub-control boards may be distinct control boards (e.g., disposed at or within the connected household appliance) that each are in operative communication with the main control board of the connected household appliance such as via a wiring harness positioned within the connected household appliance.

At 340, the method 300 includes obtaining the appliance identifier from each memory of the one or more sub-control boards in response to transmitting the one or more read requests. In some embodiments, obtaining the appliance identifier from each memory of the one or more sub-control boards includes receiving one or more request responses from the one or more sub-control boards. For example, in response to receiving the read request, each sub-control board of the one or more sub-control boards may transmit a request response that may include information or data indicative of the appliance identifier stored within the memory of the one or more sub-control boards.

In some other embodiments, obtaining the appliance identifier from each memory of the one or more sub-control boards includes retrieving the appliance identifier from the memory of each of the one or more sub-control boards. For example, at 330, the main control board may attempt to retrieve data corresponding to the appliance identifiers from the one or more sub-control boards. In such instances, the main control board may “read” data stored within each memory of the one or more sub-control boards and store the data corresponding to the appliance identifier within the memory of the main control board.

At 350, the method 300 includes analyzing the appliance identifiers obtained to determine the target device software. In some embodiments, analyzing the appliance identifiers obtained includes associating the appliance identifiers (e.g., obtained at 340) with a deployable device software from a list of deployable device software stored within a memory of the main control board. As described above, the list of deployable device software may include a plurality of deployable device software that may be stored within the memory of the main control board. In some embodiments, associating the appliance identifiers with the deployable device software includes validating or “picking” the deployable device software from the list of deployable device software based on the appliance identifiers. In such embodiments, the target device software is the deployable device software.

In additional or alternative exemplary embodiments, the one or more appliance identifiers obtained may be analyzed via any suitable method to determine the target device software from the list of deployable software stored within the memory of the controller. For example, any other suitable data processing technique, algorithms, validation, or the like may be utilized to analyzed the one or more appliance identifiers obtained to determine the target device software.

In some embodiments, the target software may include or be provided as an Application Programming Interface (API) corresponding to the external device. The API may include a unique or distinct set of protocols that facilitate or allow communication between the external device and the connected household appliance. As should be appreciated, different external devices (e.g., different make, model, etc., of external devices) may require the connected household appliance to implement unique or distinct APIs to communicate with the respective external device. Thus, as the target device software is based on the one or more device identifiers included within the connection request, the appropriate device software or API may be implemented on the connected household appliance

At 360, the method 300 includes implementing the target device software. As should be appreciated, the target software may correspond to the external device (e.g., the external device that the connection request was received from, such as at 320) and the connected household appliance. In some embodiments, implementing the target device software includes changing the device software condition of the selected deployable device software (e.g., from the list of deployable device software) to TRUE. In other words, the appropriate software (e.g., the appropriate API) that corresponds to the external device and the connected household appliance may be initialize and utilized to communicate with the external device.

At 370, the method 300 includes communicating with the external device according to a communication protocol of the target device software in response to implementing the target device software. In some embodiments, communicating with the external device according to the set of protocols of the target device software includes receiving one or more operational commands from the external device, and directing one or more components of the connected household appliance according to the one or more operational commands received. For example, following the implementation of the target device software, the external device may be capable of communicating with the connected household appliance to control or direct operation of the connected household appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A connected household appliance comprising:
one or more sub-control boards each comprising a memory having an appliance identifier corresponding to the connected household appliance stored therein; and
a main control board in operative communication with the one or more sub-control boards, the main control board being operable for:
transmitting one or more read requests to the one or more sub-control boards,
obtaining the appliance identifier from each memory of the one or more sub-control boards in response to transmitting the read request, and
implementing a target device software corresponding to an external device based on the appliance identifiers obtained.

2. The connected household appliance of claim 1, wherein the main control board is further operable for:
detecting a boot up process of the connected household appliance prior to transmitting one or more read requests to the one or more sub-control boards.

3. The connected household appliance of claim 1, wherein the main control board is further operable for:
receiving a connection request comprising one or more device identifiers of the external device prior to implementing the target device software.

4. The connected household appliance of claim 1, wherein the main control board is further operable for:
analyzing the appliance identifiers obtained to determine the target device software prior to implementing the target device software.

5. The connected household appliance of claim 4, wherein analyzing the appliance identifiers obtained to determine the target device software comprises
associating the appliance identifiers obtained with a list of deployable device software stored within a memory of the main control board, and
selecting the target device software from the list of deployable device software based on the appliance identifiers obtained.

6. The connected household appliance of claim 1, wherein the main control board is further operable for:
communicating with the external device according to a set of protocols of the target device software in response to implementing the target device software.

7. The connected household appliance of claim 1, wherein communicating with the external device according to the set of protocols of the target device software comprises
receiving one or more operational commands from the external device, and
directing one or more components of the connected household appliance according to the one or more operational commands received.

8. The connected household appliance of claim 1, wherein the appliance identifiers comprise at least one of a model number, a make, or an appliance category of the connected household appliance.

9. The connected household appliance of claim 1, wherein the target device software comprises an Application Programming Interface corresponding to the external device.

10. The connected household appliance of claim 1, wherein the main control board is separate from the one or more sub-control boards.

11. A method for selecting a device software for a connected household appliance, the connected household appliance comprising one or more sub-control boards each comprising a memory having an appliance identifier corresponding to the connected household appliance stored therein, and a main control board in operative communication with the one or more sub-control boards, the method comprising:
transmitting one or more read requests to the one or more sub-control boards;
obtaining the appliance identifier from each memory of the one or more sub-control boards in response to transmitting the read request; and
implementing a target device software corresponding to an external device based on the appliance identifiers obtained.

12. The method of claim 11, further comprising:
detecting a boot up process of the connected household appliance prior to transmitting one or more read requests to the one or more sub-control boards.

13. The method of claim 11, further comprising:
receiving a connection request comprising one or more device identifiers of the external device prior to implementing the target device software.

14. The method of claim 11, further comprising:
analyzing the appliance identifiers obtained to determine the target device software prior to implementing the target device software.

15. The method of claim 14, wherein analyzing the appliance identifiers obtained to determine the target device software comprises
associating the appliance identifiers obtained with a list of deployable device software stored within a memory of the main control board, and
selecting the target device software from the list of deployable device software based on the appliance identifiers obtained.

16. The method of claim 11, further comprising:
communicating with the external device according to a set of protocols of the target device software in response to implementing the target device software.

17. The method of claim 11, wherein communicating with the external device according to the set of protocols of the target device software comprises
receiving one or more operational commands from the external device, and
directing one or more components of the connected household appliance according to the one or more operational commands received.

18. The method of claim 11, wherein the appliance identifiers comprise at least one of a model number, a make, or an appliance category of the connected household appliance.

19. The method of claim 11, wherein the target device software comprises an Application Programming Interface corresponding to the external device.

20. The method of claim 11, wherein the main control board is separate from the one or more sub-control boards.
